(19) United States
(12) Patent Application Publication
(10) Pub. No.: US 2011/0033797 A1
(43) Pub. Date: Feb. 10, 2011

(54) IMAGE FORMATION APPARATUS

(75) Inventor: Akinori Koyama, Osaka (JP)

Correspondence Address: K&L Gates LLP, P.O. Box 1135, CHICAGO, IL, 60690, US

(73) Assignee: Kyocera Mita Corporation, Osaka (JP)

(21) Appl. No.: 12/538,595

(22) Filed: Aug. 10, 2009

(51) Int. Cl. G03G 13/16; G03G 15/06

(52) U.S. Cl. 430/125.3; 399/222

(57) ABSTRACT

An image formation apparatus including: a two-component developer that contains toner and carrier; a photoconductor that forms a toner image by the two-component developer; and an intermediate transfer body to which the toner image on the photoconductor is transferred. The intermediate transfer body has a surface layer that is provided on a transfer surface of the intermediate transfer body onto which the toner image is transferred and that contains a first fluoropolymer. The carrier has a carrier core particle and a coat layer that is provided on a surface of the carrier core particle and that contains a second fluoropolymer. The toner is positively charged.

### BACKGROUND

1. Field of the Invention

The present invention relates to an image formation apparatus that uses a two-component developer, and that is provided with an intermediate transfer body.

In addition, the present invention relates to an image formation apparatus that uses a two-component developer.

2. Description of the Related Art

In image formation apparatuses such as a copier, printer, or the like, one method of forming images is the direct transfer method which forms a toner image on a photoconductor, and which subsequently performs a direct transfer of this toner image onto a recording medium such as paper. Another method is the intermediate transfer method which first transfers a toner image that is formed on a photoconductor onto an intermediate transfer body (primary transfer), and subsequently transfers the toner image that was transferred to the intermediate transfer body to a recording medium (secondary transfer). See, e.g., Japanese Patent Application, First Publication No. 11-174731.

These types of methods, in particular, are frequently used in full-color image formation apparatuses. With respect to such image formation apparatuses, an intermediate transfer belt composed of elastic material, such as resin or rubber, is frequently used as the intermediate transfer body. For example, in the apparatuses of Japanese Patent Application, First Publication No. H11-24429 and Japanese Patent Application, First Publication No. H08-50419, a fluoropolymer which has excellent durability and satisfactory separability is used in the surface layer of the intermediate transfer belt.

As for the developer, there are image formation apparatuses which use a two-component developer that has a toner and a carrier. Among these apparatuses, in particular, with respect to full-color image formation apparatuses, there is a trend toward reducing the particle diameter of the toner in order to achieve images of a higher quality, and concomitantly reducing the particle diameter of the carrier as well.

The toner image that is transferred to the recording medium by the direct transfer method and the intermediate transfer method is ordinarily fixed to the recording medium by a fixing device. With respect to the fixing device, a widely used apparatus includes a fixing roll (fixing member) that incorporates a heater and a pressure roll (pressure member) that is paired with the fixing roll when installed.

However, when the particle diameter of the carrier is small, carrier jump tends to occur during the formation of the toner image on the photoconductor, and the carrier tends to migrate from the developing apparatus to the photoconductor. Furthermore, there is a tendency for the carrier to also migrate from the photoconductor to the intermediate transfer belt. As magnetic particles or the like with a high degree of hardness are frequently used in the carrier, the surface of the intermediate transfer belt can be scratched when the carrier adheres with sufficient strength to the surface of the intermediate transfer belt, resulting in the generation of image defects.

In this regard, in the case of an intermediate transfer belt having a surface layer formed from fluoropolymer, the surface layer has a strongly negative electric charge due to the fluoropolymer. Consequently, there are situations where the adhering carrier undergoes frictional electrification, and, therefore, more strongly adheres due to electrostatic force.

Furthermore, particularly with respect to full-color image formation apparatuses that emphasize image quality, many are provided with a function that forcibly ejects degraded toner inside the developing apparatus to the photoconductor. In such an apparatus, a large volume of toner migrates to the photoconductor at one time during the forced ejection. Consequently, this causes a problem in that the carrier also tends to migrate onto the photoconductor together with the toner and migrates further to the intermediate transfer belt, thereby facilitating the occurrence of the aforementioned image defects.

### SUMMARY

The present invention was developed, in part, in view of the foregoing circumstances, and an advantage is to provide an image formation apparatus that inhibits image defects due to the scratching of the surface of an intermediate transfer body such as an intermediate transfer belt by a carrier even when, for example, carriers having small particle diameters are used.

There are situations where a carrier that migrates to the photoconductor due to carrier jump is transferred from the photoconductor to the surface of the recording medium, and migrates further to the fixing roll of the fixing device. As particles of magnetic material having a high degree of hardness are often used in the carrier, when the carrier adheres with sufficient strength to the surface of the fixing roll, scratching of the surface of the fixing roll occurs, resulting in the generation of image defects. Such an adhesion of carrier to the fixing roll tends to occur particularly when high-density printing of photographs or the like is conducted by the direct transfer method in which a toner image is transferred from the photoconductor to the recording medium without the interposition of an intermediate transfer body.

The present invention was developed, in part, in view of the foregoing circumstances, and an advantage is to provide an image formation apparatus that inhibits image defects due to a scratching of the surface of a fixing member of a fixing device by a carrier even when, for example, a carrier having a small particle diameter is used.

With respect to the first advantage, the present invention provides, in an embodiment:

An image formation apparatus, including: a two-component developer that contains toner and a carrier; a photoconductor that forms a toner image using the two-component developer; and an intermediate transfer body to which the toner image on the photoconductor is transferred. The intermediate transfer body has a surface layer that is provided on a transfer surface of the intermediate transfer body onto which the toner image is transferred and comprises a first fluoropolymer. The carrier has a carrier core particle and a coat layer that is provided on a surface of the carrier core particle and that comprises a second fluoropolymer. The toner is positively charged.

Pursuant to an embodiment of the image formation apparatus, it is possible to inhibit image defects due to the scratching of the surface of an intermediate transfer body by a carrier even when, for example, carriers having small particle diameter are used.

In an embodiment, the first fluoropolymer and the second fluoropolymer may comprise substantially the same materials. This configuration reduces the occurrence of frictional electrification of the carrier.

Pursuant to an embodiment of the image formation apparatus, the mass-average particle diameter of the carrier core particle may be 40 μm or less. Due to use the carrier core particles having small particle diameters, it is possible to impart high image quality to the images that are formed. However, carrier jump tends to occur under such conditions. In this image formation apparatus, it is possible to inhibit image defects due to the scratching of the surface of an intermediate transfer body by the carrier even if carrier jump frequently occurs.

In an embodiment of the image formation apparatus, the first fluoropolymer and the second fluoropolymer may contain polymers or copolymers including one or more selected from the group consisting of: vinylidene fluoride, tetrafluoroethylene, hexafluoropropylene, monochlorotrifluoroethylene, monofluoroethylene, and trifluoroethylene. It is therefore possible to form a fluoropolymer that is compatible with the image formation apparatus and inhibits carrier adhesion.

In an embodiment of the image formation apparatus, the first fluoropolymer and the second fluoropolymer may contain one or more polymers and copolymers selected from the group consisting of: tetrafluoroethylene-perfluoroalkylvinylether copolymer, and polytetrafluoroethylene. This allows a fluoropolymer to be obtained that not only inhibits carrier adhesion, but also has sufficient heat resistance and strength.

In another embodiment of the present invention, an image formation apparatus is provided, including: a two-component developer that contains toner and a carrier; a photoconductor that forms a toner image using the two-component developer; and a fixing device which fixes the toner image that has been transferred from the photoconductor to a recording medium. The fixing member of the fixing device has a surface layer that comprises a first fluoropolymer. The carrier has a carrier core particle and a coat layer that is provided on the surface of the carrier core particle and comprises a second fluoropolymer, and the toner is positively charged. Pursuant to this image formation apparatus, it is possible to inhibit image defects due to the scratching of the fixing device by a carrier even when, for example, carriers having small particle diameters are used.

In an embodiment of the image formation apparatus, the first fluoropolymer and the second fluoropolymer may comprise substantially the same materials. This configuration reduces the occurrence of frictional electrification of the carrier.

In an embodiment of the image formation apparatus, the mass average particle diameter of the carrier core particle may be 40 ∞m or less. Due to use of carrier core particles having a small particle diameter, it is possible to impart high image quality to the images that are formed. However, carrier jump tends to occur under such conditions. With this embodiment of the image formation apparatus, it is possible to inhibit image defects due to the scratching of a fixing device by a carrier even if carrier jump frequently occurs.

In an embodiment of the image formation apparatus, the toner image may be directly transferred from the photoconductor onto the recording medium. When the direct transfer method is used, the carrier tends to migrate to the fixing device when carrier jump occurs. With this embodiment of the image formation apparatus, even in such situations, it is possible to inhibit image defects due to the scratching of the fixing device by the carrier.

In an embodiment of the image formation apparatus, the first fluoropolymer and the second fluoropolymer may contain polymers or copolymers including one or more selected from the group consisting of: vinylidene fluoride, tetrafluoroethylene, hexafluoropropylene, monochlorotrifluoroethylene, monofluoroethylene, and trifluoroethylene. It is therefore possible to form a fluoropolymer that is compatible with the image formation apparatus and inhibits carrier adhesion.

In an embodiment of the image formation apparatus, the first fluoropolymer and the second fluoropolymer may contain one or more polymers or copolymers selected from the group consisting of: tetrafluoroethylene-perfluoroalkylvinylether copolymer, and polytetrafluoroethylene. This allows a fluoropolymer to be obtained that not only inhibits carrier adhesion, but that also has sufficient heat resistance and strength.

Additional features and advantages are described herein, and will be apparent from the following Detailed Description and the figures.

### BRIEF DESCRIPTION OF THE FIGURES

In the accompanying drawings:

FIG. 1 is a schematic block diagram that shows an embodiment of the image formation apparatus of the present invention.

FIG. 2 is schematic cross-sectional view that shows the carrier of the embodiment of the image formation apparatus of FIG. 1.

FIG. 3 is a schematic cross-sectional view that shows the intermediate transfer belt of the embodiment of the image formation apparatus of FIG. 1.

FIG. 4 is a schematic block diagram that shows another embodiment of the image formation apparatus of the present invention.

FIG. 5 is a schematic cross-sectional view that shows the fixing roll of the embodiment of the image formation apparatus of FIG. 2.

### DETAILED DESCRIPTION

Referring now to the drawings, an embodiment of the image formation apparatus of the present invention will now be described in detail.

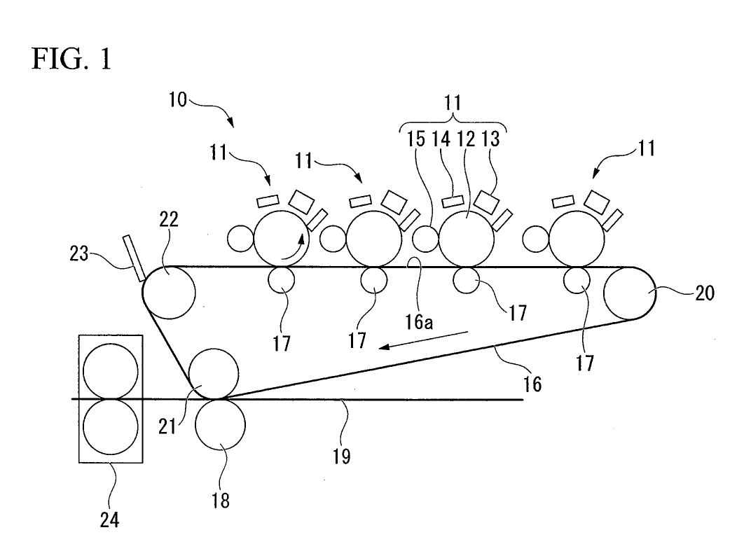

FIG. 1 is a schematic block diagram that shows some of the components of a tandem type full-color image formation apparatus (hereinafter, “image formation apparatus”) 10. This image formation apparatus 10 includes image formation units 11, each of which accommodates the respective color of yellow (Y), magenta (M), cyan (C), or black (BK).

Each image formation unit 11 is provided with: a photoconductor drum photoconductor) 12 that contains an amorphous silicon (a-Si) photoconductor, organic photoconductor (OPC), or the like; a charging unit 13; an exposure unit 14; and a developing apparatus 15. A two-component developer that contains a toner and a carrier 30 is housed in the developing apparatus 15. Toner images are formed on the photoconductor drum.

In each image formation unit 11, the surface of the photoconductor drum 12 that is charged by the charging unit 13 is exposed by the exposure unit 14 and an electrostatic latent image is formed. The toner image is formed on the photoconductor drum 12 by developing the electrostatic latent image with the developing apparatus 15.

Moreover, the image formation apparatus 10 includes an intermediate transfer belt (intermediate transfer body) 16 onto which the toner image that is formed on the photoconductor drums 12 is transferred in the aforementioned manner. The toner image that is formed on the photoconductor drums 12 is transferred onto the surface—that is, a transfer surface 16a—of the intermediate transfer belt 16 by the action of primary transfer rolls 17 that are positioned opposite each image formation unit 11.

The toner image that is transferred in this manner to the transfer surface 16a of the intermediate transfer belt 16 is further transferred to a final recording medium 19, such as paper, by a secondary transfer roll 18.

The image formation apparatus 10 in this embodiment is provided with a forced ejection member that is omitted from the drawing. Using this member, degraded toner inside the developing apparatus 15 can be forcibly ejected to the photoconductor drum 12. The image formation apparatus 10 of this embodiment provides a cleaning unit that is omitted from the drawings, whereby forcibly ejected toner can be recovered.

Reference number 20 in the figure is a drive roll of the intermediate transfer belt 16, reference number 21 is a back-up roll of the secondary transfer roll 18, reference number 22 is a tension roll, reference number 23 is a cleaning blade, and reference number 24 is a fixing device.

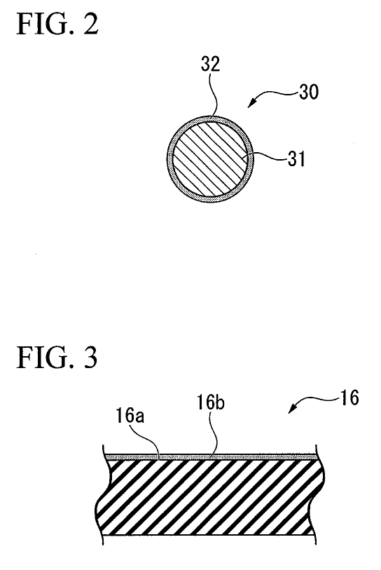

FIG. 2 is a schematic cross-sectional view that shows a below-mentioned carrier 30 pertaining to the present embodiment. FIG. 3 is a schematic cross-sectional view that shows the intermediate transfer belt 16 of the image formation apparatus 10 relating to the present embodiment. The dimensions of each component in the schematic cross-sectional views of FIG. 2 and FIG. 3 do not specifically indicate the dimensions of each component of the present embodiment, but are depicted with appropriate adjustments for the purposes of convenience in the figures.

With respect to the image formation apparatus 10, a surface layer 16b that contains a fluoropolymer is formed on the transfer surface 16a of the intermediate transfer belt 16. A carrier 30 is housed in the developing apparatus 15.

The carrier 30 includes carrier core particles 31 and a coat layer 32 that is formed on the surface of the carrier core particles 31 and that contains a fluoropolymer. Accordingly, both the transfer surface 16a of the intermediate transfer belt 16 and the surface of the carrier 30 have excellent separability.

In the image formation apparatus 10, carrier jump may occur when the toner image is formed on the photoconductor drum 12. When carrier jump occurs, the carrier 30 migrates from the developing apparatus 15 to the photoconductor drum 12. Furthermore, the carrier 30 may also migrate from the photoconductor drum 12 to the transfer surface 16a of the intermediate transfer belt 16. Even in such situations, using the image formation apparatus 10 of the present embodiment, it is difficult for the carrier 30 to adhere, with sufficient strength, to the transfer surface 16a. As both the coat layer 32 of the carrier 30 and the surface layer 16b of the intermediate transfer belt 16 have a fluoropolymer, frictional electrification of the carrier 30 is inhibited. Consequently, it is difficult for electrical attraction to occur between the carrier 30 and the intermediate transfer belt 16. As a result, even if the carrier 30 adheres to the transfer surface 16a of the intermediate transfer belt 16, it can be easily removed and image defects due to the scratching of the transfer surface 16a by the carrier 30 can be inhibited.

Here, as the fluoropolymer that is used in the surface layer 16b of the intermediate transfer belt 16 and the coat layer 32 of the carrier 30, one may use polymers or copolymers or the like including, for example, vinylidene fluoride, tetrafluoroethylene, hexafluoropropylene, monochlorotrifluoroethylene, monofluoroethylene, and trifluoroethylene. Among these, from the standpoints of heat resistance and strength, tetrafluoroethylene-perfluoroalkylvinylether copolymer (PFA) and polytetrafluoroethyhlene (PTFE) are preferable.

While it is acceptable to use different types of fluoropolymer in the surface layer 16b of the intermediate transfer belt 16 and the coat layer 32 of the carrier 30, it is preferable to use the same type or substantially the same composition of fluoropolymer, because frictional electrification is better inhibited.

The following method may be used as a method of forming the surface layer 16b of the intermediate transfer belt 16. First, an application liquid is prepared by dispersing, for example, a resin composition containing the above-described fluoropolymer in a suitable solvent. This application liquid can be applied by a conventional method such as spraying, dipping, brushing or the like to the surface of a belt base material composed of, for example, chloroprene rubber, polyamide-imide, polyurethane, or acrylic resin. Subsequently, a coating film (surface layer 16b) is formed by hardening, or the like, by drying, baking, and optical irradiation. It is preferable that the thickness of the surface layer 16b that is formed in this manner is from 3-30 μm, and 10-25 μm is preferable.

It is optimal for the application liquid to contain, apart from the fluoropolymer, a resin ingredient that acts as a binder. The resin ingredient, may be a resin such as polyurethane resin, acrylic resin, phenol resin, melamine resin, alkyd resin, silicon resin, epoxy resin, and unsaturated polystyrene resin; one or more of these may be used. Among these, polyurethane resin is preferable from the standpoint of compatibility with fluoropolymer. It is also acceptable for the application liquid to contain other ingredients, for example, one may use carbon black, barium titanate, etc.

As the fluoropolymer content of the surface layer 16b, a 20-90 mass % is preferable. When the fluoropolymer content is less than a 20 mass %, the effects from the use of the fluoropolymer tend to be not fully obtainable. When the fluoropolymer content exceeds a 90 mass %, adhesion with the belt base material is poor and the surface layer 16b tends to peel off from the belt base material. A preferable content would be a 30-80 mass %.

As a method of forming the coat layer 32 of the carrier 30, the following method or the like can be used. First, a dispersion liquid for coating is prepared by dispersing, for example, a resin composition containing the aforementioned fluoropolymer in a suitable solvent. After bringing the coating dispersion liquid into contact with the carrier core particles 31, to cause an adhesion of the coating dispersion liquid to the surface of the carrier core particles 31, a drying and baking process are suitably conducted. When the coating dispersion liquid is brought into contact with the carrier core particles 31, one may use a coating apparatus using a fluidized bed, a coating apparatus using the dipping method, or the like.

Here, it would be optimal for the coating dispersion liquid to contain, apart from the fluoropolymer, a resin ingredient that acts as a binder. The resin ingredient, may include a resin such as polyurethane resin, acrylic resin, phenol resin, melamine resin, alkyd resin, silicon resin, epoxy resin, and unsaturated polystyrene resin; one or more of these may be used. From the standpoint of compatibility with fluoropolymer, polyurethane resin is preferable.

With respect to the mass ratio of the fluoropolymer in the coating dispersion liquid relative to the carrier core particles 31, fluoropolymer/carrier core particles having a ratio of 0.1/100-10/100 are preferable.

With respect to the mass ratio of the fluoropolymer and the resin ingredient that acts as a binder, a ratio of 1/10-10/1 is preferable.

With respect to the carrier core particles 31, one may use known constituents such as particles of magnetic material, or resin particles obtained by dispersing magnetic material in binder resin.

As the magnetic material, one may use, for example, magnetic metals such as iron, nickel, and cobalt, and alloys thereof; or alloys containing rare earths; soft ferrites such as hematite, magnetite, manganese-zinc based ferrite, nickel-zinc based ferrite, manganese-magnesium based ferrite, and lithium based ferrite; or iron based oxides such as copper-zinc based ferrite; or mixtures of these. The particles of magnetic material are manufactured by conventional methods such as the sintering method or the atomizing method.

As the binder resin, one may use, for example, vinyl resin, polyester resin, epoxy resin, phenol resin, urea resin, polyurethane resin, polyimide resin, cellulose resin, polyether resin, and mixtures of these, or the like.

As for the particle diameter of the carrier 30 on the surface of which the coat layer 32 is formed, it is sufficient if it is within a range that is suitable for use as a carrier, but with respect to full-color image formation apparatuses that require particularly high image quality, carriers of small particle diameter are often used. Carrier jump tends to occur easily with carriers of smaller particle diameter. In the present embodiment, a surface layer 16b containing a fluoropolymer is formed on the transfer surface 16a of the intermediate transfer belt 16, and a coat layer 32 containing a fluoropolymer is formed on the surface of the carrier 30. In this situation, the carrier 30 does not adhere sufficiently strong to the transfer surface 16a even when carrier jump occurs, the carrier 30 migrates from the developing apparatus 15 to the photoconductor drum 12, and the carrier 30 further migrates from the photoconductor drum 12 to the transfer surface 16a of the intermediate transfer belt 16. As a result, it is possible to inhibit image defects that occur due to the scratching of the transfer surface 16a by the carrier 30.

Consequently, according to this embodiment of the image formation apparatus 10, image defects can be fully inhibited even when carriers 30 having a small particle diameter are used where the mass average particle diameter of the carrier core particles 31 is 40 μm or less.

Furthermore, in addition to being provided with a forced ejection member (not illustrated in the drawings) that forcibly ejects degraded toner inside the developing apparatus 15 to the photoconductor drum 12, the image formation apparatus 10 of the present embodiment may also be provided with a cleaning unit (not illustrated in the drawings) that recovers the forcibly ejected toner. When forced ejection occurs, there is a risk that a large volume of degraded toner will migrate at one time onto the photoconductor drum 12. Even in such situations, when a surface layer 16b containing a fluoropolymer is formed on the transfer surface 16a of the intermediate transfer belt 16 and a coat layer 32 containing a fluoropolymer is formed on the surface of the carrier 30, the carrier 30 does not strongly adhere to the transfer surface 16a. Consequently, image defects originating in adhesion of the carrier 30 can be inhibited.

In an embodiment of the image formation apparatus 10, a positively charged toner is used as the toner that comprises the two-component developer together with the carrier 30. For example, one may use a toner obtained by dispersing coloring agents, charge control agents for positive charge properties, release agents, and so on in the binder resin, conducting granulation, and externally adding conventional charge control agents, fluidity enhancers, and so on as desired. As positively charged toner in this embodiment of the image formation apparatus 10, one may also externally add, for example, positively charged silica microparticles or the like.

When positively charged toner is used, and when a carrier 30 is used that exhibits a strongly negative charge due to its fluoropolymer content, a high charging performance and a stable charging volume are obtained. At the same time, the separation of the toner from the carrier 30 is also enhanced. Consequently, spent toner (adhesion of toner components to the carrier surface) can be prevented.

Theremoplastic resin and thermohardening resin may be used as the binder resin. For example, one may use vinyl aromatic resins such as polystyrene, styrene-acrylic copolymer, acrylic resin, polyvinyl acetol resin, polyester resin, epoxy resin, phenol resin, etc. As the charge control agent for providing positive charge properties, one may use nigrosine base, quaternary ammonium salt, or the like.

In situations where a charge control agent is not used, and where a portion of the charge control action is provided by the binder resin, one may use resins having cationic polar groups, as a portion of the binder resin. As the cationic polar groups, one may use basic nitrogenous groups such as primary, secondary, or tertiary amino groups, quaternary ammonium groups, amide groups, imino groups, imide groups, hydrazine groups, guanizine groups, and amidino groups.

As the coloring agents, one may use, for example, the following pigments: as black pigment, carbon black such as acetylene black, lampblack, and aniline black; as yellow pigment, chrome yellow, zinc chromate, cadmium yellow, yellow iron oxide, mineral fast yellow, nickel titanium yellow, Naples Yellow, naphthol yellow S, Hansa Yellow G, Hansa Yellow 10G, benzidine yellow G, benzidine yellow GR, Quinoline Yellow Lake, Permanent Yellow NCG, and Tartrazine Lake; as orange pigment, chrome red, molybdenum orange, Permanent Orange GTR, Pyrazolon Orange, Balkan Orange, Indanthrene Brilliant Orange RK, benzidine orange G, and Indanthrene Brilliant Orange GK; as red pigment, Bengala, cadmium red, red lead, cadmium mercuric sulfide, Permanent Red 4R, Lithol Red, Pyrazolon Red, Watchung Red Calcium Salt, Lake Red D, Brilliant Carmine 6B, Eosin Lake, Rhodamine Lake B, Alizaline Lake, and Brilliant Carmine 3B; as violet pigment, manganese violet, Fast Violet B, and Methyl Violet Lake; as blue pigment, iron blue, cobalt blue, Alkali Blue Lake, Victoria Blue Lake, phthalocyanine blue, non-metallic phthalocyanine blue, partial chlorination product of phthalocyanine blue, First Sky Blue, and Indusren Blue BC; as green pigment, chrome green, chrome oxide, Pigment Green B, Malachite Green Lake, and Final Yellow Green G; and as white pigment, Chinese white, titanium oxide, antimony white, zinc sulfide, baryte powder, barium carbonate, clay, silica, white carbon, talc, alumina white, or the like.

As the release agents, one may use all types of natural wax and synthetic wax such as polyolefin type wax. With respect to the number-average molecular weight (Mn) of polyolefin type wax, 1,000-10,000 is preferable, and 2,000-6,000 is more preferable. As the polyolefin, one may use polypropylene, polyethylene, propylene-ethylene copolymer, or the like, but polypropylene is particularly preferable.

As explained above, according to the embodiment of the image formation apparatus 10 illustrated in the drawings, it is possible to prevent adhesion of the carrier 30 to the surface—that is, the transfer surface 16a—of the intermediate transfer belt 16 even if a carrier 30 having a small particle diameter is used. As a result, it is possible to inhibit image defects due to the scratching of the transfer surface 16a by the carrier 30.

By way of example and not limitation, an example of an embodiment of the present invention is described below in detail.

(1) Manufacture of Intermediate Transfer Belt

A polyurethane resin composition containing PFA into which an appropriate amount of carbon black had been blended was dispersed in a solvent of tetrahydrofuran (THF) and the application liquid was prepared. The proportions of each ingredient in the application liquid were as follows: 5 mass % of carbon black; 65 mass % of PFA; and 30 mass % of polyurethane. Next, this application liquid was applied to the surface of a chloroprene rubber belt (thickness: 500 μm; volume resistance value: 1×1010 Ω-cm; and JIS-A hardness: 75 degrees) which was the belt base material and the product was baked for 30 minutes at 140-160° C. A surface layer was formed on the surface of the belt base material to produce the intermediate transfer belt.

The volume resistance value of the produced intermediate belt was 1×1012 Ω-cm, its surface roughness Rz was 5 μm, and thickness of the surface layer was 20 μm.

(2) Manufacture of Toner (Positively Charged Toner)

After stirring and mixing the materials set forth below in a Hensel mixer, fusion and kneading were performed by a double-shaft extruder. Jet mill pulverization was then performed and wind-driven classification was performed by a classifier to obtain bulk powder particles of toner having a volume-average particle diameter of 6.5 μm.

Materials:

Binder resin SE-0040 (manufactured by Sekisui Chemical Co.): 100 mass parts

Carbon black MA-100 (manufactured by Mitsubishi Chemical): 6.0 mass parts

Charge control agent (N-07, manufactured by Orient Chemical): 4.0 mass parts

Release agent (Camauba Wax, manufactured by Toa Kasei Co.): 4.0 mass parts

Relative to 100 mass parts of this toner bulk powder, 1.2 mass parts of positively charged silica microparticles (RA200, manufactured by Aerosil) underwent blending treatment in the aforementioned mixer/stirrer to obtain the toner.

### WORKING EXAMPLE 1

The dispersion liquid for coating was prepared by dispersing a mixture of PFA (copolymer of tetrafluoroethylene and perfluoroalkylvinylether) and polyurethane resin (mass ratio 1:1) in a solvent.

THF was used as the solvent and the concentrations of PFA and polyurethane resin in the coating dispersion liquid were each 20 mass %. Next, 100 mass parts of carrier core particles (manufactured by Powder-Tech Co., mass average particle diameter: 40 μm and saturated magnetization: 65 emu/g) composed of ferrite and 3 mass parts of the aforementioned mixture of PFA and polyurethane resin were introduced into a coating apparatus (Spir-A-Flow “Mini,” manufactured by Freund Industries Corp.) using a fluidized bed method. By this means, the coating dispersion liquid was made to adhere to (coat) the carrier core particles. Subsequently, the particles were left in a 200° C. oven for 3 hours to produce a carrier on the surface of which a coat layer was formed.

Next, an apparatus (image formation apparatus “KM-C850 modified apparatus,” manufactured by Kyocera Mita Corp.) attaching the intermediate transfer belt that was manufactured in (1) above was prepared. A two-component developer composed of the toner that was manufactured in (2) above and the produced carrier was placed in a black developing unit of the image formation apparatus. The toner was placed in a black container. The two-component developer was prepared by mixing 100 mass parts of carrier and 8 mass parts of toner in a bowl mill.

Under conditions of 2% duty, A4-size copy paper was continuously printed. During the printing, a gray image was outputted every 5000 pages, and it was determined whether or not white spots were occurring due to the scratching of the intermediate transfer belt.

At the same time, the surface (transfer surface) of the intermediate transfer belt was observed and it was determined whether or not scratching was occurring.

Furthermore, blank pages were outputted, and “background discoloration” was calculated according to formula (i).

Background discoloration=reflection density of paper in printing area of blank paper−reflection density of paper before output. Formula (i):

When it was found that “background discoloration” was 0.01 or higher, a determination of “background discoloration occurrence” was made.

In addition, header images were outputted. When it was found that reflection density (ID) was 0.8 or less, it was treated as a defective ID.

Reflection density was measured with “TC-6DS” manufactured by Tokyo Denshoku Co. The evaluation results are shown in Table 1.

During printing, operations were conducted to forcibly eject toner that was equivalent to 100% duty at a rate of once every 50 printed sheets.

### WORKING EXAMPLE 2

The same procedure and evaluation were conducted as in Working Example 1, except that PTFE (polytetrafluoroethylene) was used instead of PFA in preparing the coating dispersion liquid. The evaluation results are shown in Table 1.

### WORKING EXAMPLE 3

The same procedure and evaluation were conducted as in Working Example 1, except that ferrite with a volume-center particle diameter of 45 μm was used as the carrier core particles. The evaluation results are shown in Table 1.

### REFERENCE EXAMPLE 1

The same procedure and evaluation were conducted as in Working Example 1, except that silicon resin was used instead of PFA in preparing the coating dispersion liquid and ferrite with a volume-center particle diameter of 45 μm was used as the carrier core particles. The evaluation results are shown in Table 1.

### REFERENCE EXAMPLE 2

The same procedure and evaluation were conducted as in Working Example 1, except that silicon resin was used instead of PFA in preparing the coating dispersion liquid. The evaluation results are shown in Table 1.

### REFERENCE EXAMPLE 3

The same procedure and evaluation were conducted as in Reference Example 2, except that operations to forcibly eject the toner were not conducted. The evaluation results are shown in Table 1.

TABLE 1

| | Particle | | Are forced | | Is there | | |
|---|---|---|---|---|---|---|---|
| | diameter of | Resin | ejection | | scratching of | Occurrence of | Existence |
| | carrier core | contained in | operations | Occurrence of | intermediate | background | of ID |
| | particles (μm) | coating layer | conducted? | white spots | transfer belt? | discoloration | defects |
| Working | 40 | PFA | Yes | Not until | No | Not until | None |
| Example 1 | | | | 100,000 sheets | | 100,000 sheets | |
| Working | 40 | PTFE | Yes | Occurs at | Somewhat | Not until | None |
| Example 2 | | | | 80,000 sheets | yes | 100,000 sheets | |
| Working | 45 | PFA | Yes | Not until | No | Occurs at | None |
| Example 3 | | | | 100,000 sheets | | 65,000 sheets | |
| Reference | 45 | Silicon | Yes | Occurs at | Yes | Occurs at | None |
| Example 1 | | | | 70,000 sheets | | 20,000 sheets | |
| Reference | 40 | Silicon | Yes | Occurs at | Yes | Occurs at | None |
| Example 2 | | | | 20,000 sheets | | 50,000 sheets | |
| Reference | 40 | Silicon | No | Not until | No | Occurs at | Occurs at |
| Example 3 | | | | 100,000 sheets | | 50,000 sheets | 10,000 |
| | | | | | | | sheets |

As shown in Table 1, according to each working example, there is well-balanced inhibition with respect to the occurrence of white spots, the scratching of intermediate transfer belt, background discoloration, and ID defects.

The image formation apparatus of another embodiment of the present invention will now be described in detail using drawings.

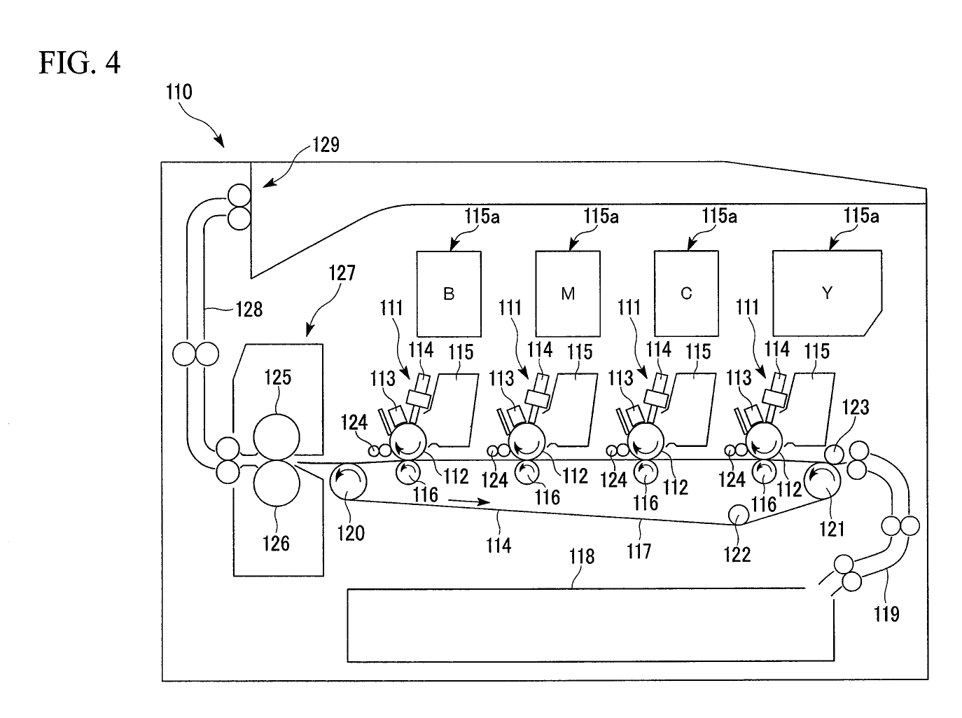

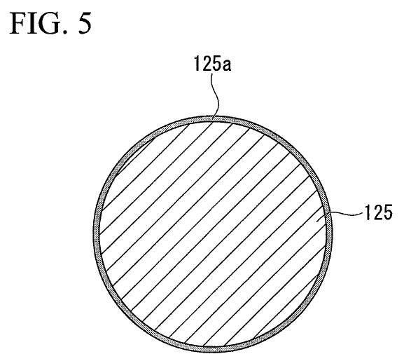

FIG. 4 is a schematic block diagram that shows one example of a direct-transfer quadruple-tandem type color image formation apparatus (hereinafter, “image formation apparatus”) 110. This image formation apparatus 110 is provided with image formation units 111, each of which accommodates the respective color of yellow (Y), magenta (M), cyan (C), or black (BK).

Each image formation unit 111 is provided with: a photoconductor drum (photoconductor) 112 that includes an amorphous silicon (a-Si) photoconductor, an organic photoconductor (OPC), or the like, and that forms the toner image; a charging unit 113; an exposure unit 114; and a developing apparatus 115. A two-component developer that contains toner and carrier is housed in the developing apparatus 115. A toner supply container 115a that functions to supply toner of the respective color is provided in the vicinity of each developing apparatus 115.

In each image formation unit 111, the surface of the photoconductor drum 112 that is charged by the charging unit 113 is exposed by the exposure unit 114 and an electrostatic latent image is formed. The toner image is formed on the photoconductor drum 112 by developing the electrostatic latent image with the developing apparatus 115.

Moreover, each image formation unit 111 is provided with a transfer roll 116 that is positioned opposite each photoconductor drum 112. This image formation apparatus 110 includes a paper conveyance belt 117 that passes between the respective photoconductor drum 112 and the transfer roll 116, and that feeds a recording medium such as paper. Consequently, the toner images that are formed on the respective photoconductor drums 112 are sequentially transferred by the respective transfer rolls 116 to the surface of the recording medium that is fed by the paper conveyance belt 117 from a paper feeding apparatus 118 along a paper feed path 119.

Reference numbers 120, 121, and 122 in the drawings are respectively a drive roll, a driven roll, and an opposing roll of the paper conveyance belt. Reference number 123 is a suction roll that causes the recording medium to adhere to the surface of the paper conveyance belt. Reference number 124 is a cleaning unit.

Next, the recording medium onto which the toner image has been sequentially formed in this manner is fed to a fixing device 127 which is provided with a fixing roll (fixing member) 125 that includes a heater, and a pressure roll (pressure member) 126 that is positioned opposite this. The recording medium is then positioned and pressed between the surface (roll face) of the fixing roll 125 and the surface (roll face) of the pressure roll 126. As a result, the toner image is fixed to the recording medium. At this time, the fixing face of the recording medium (the face on which the toner image is formed) contacts the fixing roll 125, and the non-fixing face of the recording medium (the face on which the toner image is not formed) contacts the pressure roll 126.

Next, the recording medium, to which the toner image has been fixed by the fixing device 127, moves to a paper ejection path 128 and is ejected from an ejector 129.

FIG. 5 is a schematic cross-sectional view that shows the aforementioned fixing roll 125 of the image formation apparatus 110. The dimensions of each component in the schematic cross-sectional view of FIG. 5 do not specifically indicate the dimensions of each component of the present embodiment, but are depicted with suitable adjustments for the purpose of convenience in the figures.

In the aforementioned image formation apparatus 110, a surface layer 125a containing a fluoropolymer is formed on the surface of the fixing member, that is, the surface of the fixing roll 125. The carrier housed in the developing apparatus 115 includes carrier core particles and a coat layer containing a fluoropolymer that is formed on the surface of the carrier core particles. Consequently, both the surface of the fixing roll 125 and the surface of the carrier have excellent separability.

The schematic configuration of the carrier of the present embodiment may use the same configuration as the schematic configuration of the carrier 30 of the previous embodiment that is shown in FIG. 2.

Carrier jump may occur when the toner image is formed on the photoconductor drum 112 and the carrier may migrate from the developing apparatus 115 to the photoconductor drum 112. In this case, the carrier that has migrated to the photoconductor drum 112 may be transferred to the surface of the recording medium, and may further migrate to the surface of the fixing roll 125. But even in this situation, the carrier would not strongly adhere to the surface of the fixing roll 125 with sufficient strength. Moreover, as both the coat layer of the carrier and the surface layer 125a of the fixing roll 125 comprise a fluoropolymer, frictional electrification of the carrier is inhibited, as well as electrical adhesion. As a result, even if the carrier adheres to the surface of the fixing roll 125, it can be easily removed and image defects due to the scratching of the surface of the fixing roll 125 by the carrier can be inhibited.

As the fluoropolymer that is used in the surface layer 125a of the fixing roll 125 and the coat layer of the carrier, one may use polymer or copolymer of vinylidene fluoride, tetrafluoroethylene, hexafluoropropylene, monochlorotrifluoroethylene, monofluoroethylene, and trifluoroethylene. Among these, tetrafluoroethylene-perfluoroalkylvinylether copolymer (PFA), and polytetrafluoroethylene (PTFE) are preferable from the standpoint of heat resistance.

In this example, it is acceptable to use different types of fluoropolymer in the surface layer 125a of the fixing roll 125 and the coat layer of the carrier. However, from the standpoint of inhibiting frictional electrification, it is more preferable to use the same type, or substantially the same composition, of fluoropolymer.

As the method of forming the surface layer 125a of the fixing roll 125, one may use a method wherein a shrinkable tube is prepared that is composed of fluoropolymer and that has an inner diameter equal to the outer diameter of the fixing roll base material. This tube is placed over the fixing roll base material and a suitable heat treatment is performed. According to this method, the shrinkable tube composed of fluoropolymer closely adheres to the surface of the fixing roll base material and a surface layer composed of the shrinkable tube can be simply formed.

By way of example, for the shrinkable tube, one may use a “Valfron” PFA shrinkable tube manufactured by Nippon Valqua Industries, Ltd.

With respect to the thickness of the surface layer formed in this manner, 3-500 μm is preferable.

As another method of forming the surface layer 125a of the fixing roll 125, the following method can be used. A resin composition containing the aforementioned fluoropolymer is dispersed in a suitable solvent and an application liquid is prepared. This application liquid is applied to the surface of the fixing roll base material by a conventional method such as spraying, dipping, brushing, or the like, and then forms a coated layer (surface layer) as a result of hardening or the like by drying, baking, or optical irradiation.

Here, in addition to the fluoropolymer, it is preferable that the application liquid contains a resin ingredient that acts as a binder. As the resin ingredient, one may use polyurethane resin, acrylic resin, phenol resin, melamine resin, alkyd resin, silicon resin, epoxy resin, and unsaturated polystyrene resin; one or more of these may be used.

The following is an example of a method of forming the coat layer of the carrier. First, a dispersion liquid for coating is prepared by dispersing a resin composition containing the aforementioned fluoropolymer in a suitable solvent. This coating dispersion liquid is brought into contact with the carrier core particles to cause the coating dispersion liquid to adhere to the surface of the carrier core particles. Subsequently, the particles are appropriately dried and the coating is baked on. When bringing the coating dispersion liquid into contact with the carrier core particles, one may use a coating apparatus that utilizes a fluidized bed, a coating apparatus using a dipping method, or the like.

In addition to the fluoropolymer, it is preferable that the coating dispersion liquid contain a resin ingredient that acts as a binder. As the resin ingredient, one may use polyurethane resin, acrylic resin, phenol resin, melamine resin, alkyd resin, silicon resin, epoxy resin, and unsaturated polystyrene resin; one or more of these may be used. Among these, polyurethane resin is preferable from the standpoint of compatibility with fluoropolymer.

With respect to the mass ratio of the fluoropolymer in the coating dispersion liquid relative to the carrier core particles, fluoropolymer/carrier core particles having a ratio of 0.1/100-10/100 are preferable.

With respect to the mass ratio of the fluoropolymer and the resin ingredient that acts as a binder, a ratio of 1/10-10/1 is preferable.

With respect to the carrier core particles, one may use what is already public knowledge such as particles of magnetic material, or resin particles obtained by dispersing magnetic material in binder resin.

As the magnetic material, one may use, for example, magnetic metals such as iron, nickel, and cobalt, and alloys thereof; or alloys containing rare earths; soft ferrites such as hematite, magnetite, manganese-zinc based ferrite, nickel-zinc based ferrite, manganese-magnesium based ferrite, and lithium based ferrite; or iron based oxides such as copper-zinc based ferrite; or mixtures of these. The particles of magnetic material are manufactured by conventional methods such as the sintering method or the atomizing method.

As the binder resin, one may use, for example, vinyl resin, polyester resin, epoxy resin, phenol resin, urea resin, polyurethane resin, polyimide resin, cellulose resin, polyether resin, and mixtures of these, or the like.

As for the particle diameter of the carrier on the surface of which the coat layer is formed, it is sufficient if it is within a range that is suitable for use as a carrier, but with respect to full-color image formation apparatuses that require particularly high image quality, carriers of smaller particle diameter are often used. Carrier jump tends to occur easily with carriers of small particle diameter. Moreover, carrier that is transferred from the developing apparatus 115 via the photoconductor drum 112 to the surface of the recording medium tends to further migrate to the fixing roll 125 of the fixing device 127. Even in this situation, when a surface layer 125a containing a fluoropolymer is formed on the surface of the fixing roll 125, and a coat layer containing a fluoropolymer is formed on the surface of the carrier, the carrier does not adhere sufficiently strong to the surface of the fixing roll 125. As a result, it is possible to inhibit image defects due to the scratching of the surface of the fixing roll 125 by the carrier.

Consequently, according to this embodiment of the image formation apparatus 110, image defects can be fully inhibited even when carriers having a small particle diameter are used where the mass average particle diameter of the carrier core particles is 40 μm or less.

Furthermore, with respect to the direct transfer method that transfers the toner image from the photoconductor drum 112 to the recording medium without interposition of an intermediate transfer belt as in this example, the carrier tends to migrate to the fixing roll 125 when high-density printing of photographs or the like is conducted. Even in this situation, when a surface layer 125a containing a fluoropolymer is formed on the surface of the fixing roll 125 and a coat layer containing a fluoropolymer is formed on the surface of the carrier, the carrier does not adhere with sufficient strength to the surface of the fixing roll 125, and image defects that are caused thereby can be inhibited.

In this embodiment of image formation apparatus 110, a positively charged toner is used as the toner that comprises the two-component developer together with the carrier. For example, one may use a toner obtained by dispersing color agents, charge control agents for positive charge properties, release agents, and so on in binder resin, conducting granulation, and externally adding conventional charge control agents, fluidity enhancers, and so on as desired. As positively charged toner in this embodiment of the image formation apparatus 110, one may also externally add, for example, positively charged silica microparticles or the like.

When positively charged toner is used, and when a carrier is used that exhibits strongly negative charge due to its fluoropolymer content, a high charging performance and a stable charging volume are obtained. In addition, the separation of the toner from the carrier is also enhanced. Consequently, spent toner (adhesion of toner components to the carrier surface) can also be prevented.

Thermoplastic resin and thermohardening resin may be used as the binder resin. Specifically, for example, one may use vinyl aromatic resins such as polystyrene, styrene-acrylic copolymer, acrylic resin, polyvinyl acetol resin, polyester resin, epoxy resin, phenol resin, etc. As the charge control agent for providing positive charge properties, one may use nigrosine base, quaternary ammonium salt, or the like.

In situations where a charge control agent is not used, and where a portion of the charge control action is provided by the binder resin, one may use resin having cationic polar groups as a portion of the binder resin. As the cationic polar groups, one may use basic nitrogenous groups such as primary, secondary, or tertiary amino groups, quaternary ammonium groups, amide groups, imino groups, imide groups, hydrazine groups, guanizine groups, and amidino groups.

As the coloring agents, one may use, for example, the following pigments: as black pigment, carbon black such as acetylene black, lampblack, and aniline black; as yellow pigment, chrome yellow, zinc chromate, cadmium yellow, yellow iron oxide, mineral fast yellow, nickel titanium yellow, Naples Yellow, naphthol yellow S, Hansa Yellow G, Hansa Yellow 10G, benzidine yellow G, benzidine yellow GR, Quinoline Yellow Lake, Permanent Yellow NCG, and Tartrazine Lake; as orange pigment, chrome red, molybdenum orange, Permanent Orange GTR, Pyrazolon Orange, Balkan Orange, Indanthrene Brilliant Orange RK, benzidine orange G, and Indanthrene Brilliant Orange GK; as red pigment, Bengala, cadmium red, red lead, cadmium mercuric sulfide, Permanent Red 4R, Lithol Red, Pyrazolon Red, Watchung Red Calcium Salt, Lake Red D, Brilliant Carmine 6B, Eosin Lake, Rhodamine Lake B, Alizaline Lake, and Brilliant Carmine 3B; as violet pigment, manganese violet, Fast Violet B, and Methyl Violet Lake; as blue pigment, iron blue, cobalt blue, Alkali Blue Lake, Victoria Blue Lake, phthalocyanine blue, non-metallic phthalocyanine blue, partial chlorination product of phthalocyanine blue, First Sky Blue, and Indusren Blue BC; as green pigment, chrome green, chrome oxide, Pigment Green B, Malachite Green Lake, and Final Yellow Green G; and as white pigment, Chinese white, titanium oxide, antimony white, zinc sulfide, baryte powder, barium carbonate, clay, silica, white carbon, talc, alumina white, or the like.

As the release agents, one may use all types of natural wax and synthetic wax such as polyolefin type wax. With respect to the number-average molecular weight (Mn) of polyolefin type wax, 1,000-10,000 is preferable, and 2,000-6,000 is more preferable. As polyolefin, one may use polypropylene, polyethylene, propylene-ethylene copolymer, or the like, but polypropylene is preferable.

As explained above, according to the embodiment of the image formation apparatus 110 illustrated in the drawings, it is possible to prevent adhesion of the carrier to the surface of the fixing roll 125—that is, the fixing member—of the fixing device 127 even if a carrier having a small particle diameter is used. As a result, it is possible to inhibit image defects due to the scratching of the surface of the fixing roll 125 by the carrier.

### WORKING EXAMPLES

By way of example and not limitation, examples of an embodiment of the present invention will now be described below in detail.

(Manufacture of Fixing Roll)

An image formation apparatus “KM-C2360 modified apparatus” manufactured by Kyocera Mita Corp. was prepared. A PFA shrinkable tube (PFA shrinkable tube “Valfron” manufactured by Nippon Valqua Industries (Ltd.)) was put onto the surface of the fixing roll (fixing roll base material) of the apparatus. This fixing roll was subject to heat treatment of 200° C. for 3 hours. In this manner, a fixing roll having a surface layer (thickness: 300 μm) composed of PFA was manufactured.

### WORKING EXAMPLE 4

A coating dispersion liquid was prepared by dispersing a mixture of PFA (copolymer of tetrafluoroethylene and perfluoroalkylvinylether) and polyurethane resin (mass ratio 1:1) in a solvent.

As the solvent, tetrahydrofuran (THF) was used. The concentrations of PFA and polyurethane resin in the coating dispersion liquid were 20 mass %, respectively. Next, 100 mass parts of carrier core particles (manufactured by Powder-Tech Co., mass average particle diameter: 40 μm, and saturated magnetization: 65 emu/g) composed of ferrite and 3 mass parts of the aforementioned mixture of PFA and polyurethane resin were introduced into a coating apparatus (Spir-A-Flow “Mini” manufactured by Freund Industries Corp.). By this means, the coating dispersion liquid was made to adhere to (coat) the carrier core particles. Subsequently, the particles were left in a 200° C. oven for 3 hours to obtain a carrier on the surface of which a coat layer was formed.

Next, an apparatus (image formation apparatus “KM-C2360 modified apparatus,” manufactured by Kyocera Mita Corp.) with attached the fixing roll that was manufactured in the above-described manner was prepared. A two-component developer composed of positively charged toner for KM-C2360 use and the obtained carrier was set in a developing apparatus of the image formation unit. The two-component developer was prepared by mixing 100 mass parts of carrier and 8 mass parts of toner in a bowl mill.

An image of Beta black of 5 cm height×28 cm width was continuously printed and a grey image was printed every 5000 sheets. In this manner, it was determined whether white spots due to the scratching of the fixing roll were occurring.

At the same time, the surface of the fixing roll was observed to determine whether or not there was scratching.

Furthermore, blank pages were outputted, and “background discoloration” was calculated according to the above formula (i). When it was found that “background discoloration” was 0.01 or higher, a determination of “background discoloration occurrence” was made.

Reflection density was measured by “TC-6DS” manufactured by Tokyo Denshoku Co. The evaluation results are shown in Table 2.

The positively charged toner used in KM-C2360 was prepared as follows.

After stirring and mixing the below-mentioned materials in a Hensel mixer, fusion and kneading were performed by a double-shaft extruder, jet mill pulverization was conducted, and wind-driven classification was performed by a classifier to obtain bulk powder particles of toner with a volume-average particle diameter of 6.5 μm.

Materials:

Binder resin SE-0040 (manufactured by Sekisui Chemical Co.): 100 mass parts

Carbon black MA-100 (manufactured by Mitsubishi Chemical): 6.0 mass parts

Charge control agent (N-07, manufactured by Orient Chemical): 4.0 mass parts

Release agent (Camauba Wax, manufactured by Toa Kasei Co.): 4.0 mass parts

Relative to 100 mass parts of this toner bulk powder, 1.2 mass parts of positively charged silica microparticles (RA200, manufactured by Aerosil) underwent blending treatment in the aforementioned mixer/stirrer to obtain the toner.

### WORKING EXAMPLE 5

The same procedure and evaluation were conducted as in Working Example 4, except that PTFE (polytetrafluoroethylene) was used instead of PFA in preparing the coating dispersion liquid. The evaluation results are shown in Table 2.

### WORKING EXAMPLE 6

The same procedure and evaluation were conducted as in Working Example 4, except that ferrite with a mass-average particle diameter of 45 μm was used as the carrier core particles. The evaluation results are shown in Table 2.

### REFERENCE EXAMPLE 4

The same procedure and evaluation were conducted as in Working Example 4, except that silicon resin was used instead of PFA in preparing the coating dispersion liquid and ferrite with a mass-average particle diameter of 45 μm was used as the carrier core particles. The evaluation results are shown in Table 2.

### REFERENCE EXAMPLE 5

The same procedure and evaluation were conducted as in Working Example 4, except that silicon resin was used instead of PFA in preparing the coating dispersion liquid. The evaluation results are shown in Table 2.

TABLE 2

| | Particle diameter | | | Is there | Occurrence of |
|---|---|---|---|---|---|
| | of carrier core | Resin contained | Occurrence of | scratching of | background |
| | particles (μm) | in coating layer | white spots | fixing roll? | discoloration |
| Working | 40 | PFA | Not until 50,000 | No | Not until |
| Example 1 | | | sheets | | 50,000 sheets |
| Working | 40 | PTFE | Occurs at 40,000 | Somewhat yes | Not until |
| Example 2 | | | sheets | | 50,000 sheets |
| Working | 45 | PFA | Not until 50,000 | No | Occurs at |
| Example 3 | | | sheets | | 35,000 sheets |
| Reference | 45 | Silicon | Occurs at 25,000 | Yes | Occurs at |
| Example 1 | | | sheets | | 15,000 sheets |
| Reference | 40 | Silicon | Occurs at 10,000 | Yes | Occurs at |
| Example 2 | | | sheets | | 30,000 sheets |

As shown in Table 2, according to each working example, occurrence of white spots, scratching of the fixing roll surface, and background discoloration were all inhibited.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image formation apparatus, comprising:
a two-component developer comprising a toner and a carrier;
a photoconductor that forms a toner image using the two-component developer; and
an intermediate transfer body to which the toner image on the photoconductor is transferred, the intermediate transfer body has a surface layer that is provided on a transfer surface of the intermediate transfer body onto which the toner image is transferred and that comprises a first fluoropolymer;
the carrier has a carrier core particle and a coat layer on a surface of the carrier core particle and that comprises a second fluoropolymer;
and the toner is positively charged.

2. The image formation apparatus according to claim 1, wherein the first fluoropolymer and the second fluoropolymer comprise substantially the same materials.

3. The image formation apparatus according to claim 1, wherein the mass-average particle diameter of the carrier core particle is 40 μm or less.

4. The image formation apparatus according to claim 1, wherein the first fluoropolymer and the second fluoropolymer comprise polymers or copolymers selected from the group consisting of: vinylidene fluoride, tetrafluoroethylene, hexafluoropropylene, monochlorotrifluoroethylene, monofluoroethylene, and trifluoroethylene.

5. The image formation apparatus according to claim 1, wherein the first fluoropolymer and the second fluoropolymer are selected from the group consisting of: tetrafluoroethylene-perfluoroalkylvinylether copolymer, and polytetrafluoroethylene.

6. An image formation apparatus, comprising:
a two-component developer comprising a toner and a carrier;
a photoconductor that forms a toner image using the two-component developer; and
a fixing device which fixes the toner image that has been transferred from the photoconductor to a recording medium;
a fixing member of the fixing device comprising a surface layer comprising a first fluoropolymer;
the carrier comprises a carrier core particle and a coat layer on the surface of the carrier core particle that comprises a second fluoropolymer; and
the toner is positively charged.

7. The image formation apparatus according to claim 6, wherein the first fluoropolymer and the second fluoropolymer comprise substantially same materials.

8. The image formation apparatus according to claim 6, wherein the mass-average particle diameter of the carrier core particle is 40 μm or less.

9. The image formation apparatus according to claim 6, wherein the toner image is directly transferred from the photoconductor onto the recording medium.

10. The image formation apparatus according to claim 6, wherein the first fluoropolymer and the second fluoropolymer comprise polymers or copolymers.

11. The image formation apparatus according to claim 6, wherein the first fluoropolymer and the second fluoropolymer are selected from the group consisting of: tetrafluoroethylene-perfluoroalkylvinylether copolymer, and polytetrafluoroethylene.

12. The image formation apparatus according to claim 1 wherein the first and the second fluoropolymer are selected from the group consisting of: vinylidene fluoride, tetrafluoroethylene, hexafluoropropylene, monochlorotrifluoroethylene, monofluoroethylene, and trifluoroethylene.

13. The image formation apparatus according to claim 6 wherein the first and the second fluoropolymer are selected from the group consisting of: vinylidene fluoride, tetrafluoroethylene, hexafluoropropylene, monochlorotrifluoroethylene, monofluoroethylene, and trifluoroethylene.

14. A method of forming an image comprising the steps of:
providing a two-component developer comprising a toner and a carrier;
using the two-component developer to form a toner image;
transferring the toner image on the photoconductor to a member selected from the group consisting of an intermediate transfer body and a fixing device, the member having a surface layer that comprises a first fluoropolymer;
using as the carrier a carrier having core particles and a coat layer on a surface of the carrier core particles and comprises a second fluoropolymer; and
using positively charged toner.

15. An image forming device comprising:
a photoconductor that forms a toner image using a two-component developer comprising a toner and a carrier;
a surface layer that is part of means for transferring the toner image comprising a first fluoropolymer;
the carrier comprises a carrier core particle and a coat layer on the surface of the carrier core particle that comprises a second fluoropolymer; and
the toner is positively charged.
